(19) United States
(12) Patent Application Publication
(10) Pub. No.: US 2024/0220694 A1
(43) Pub. Date: Jul. 4, 2024

(54) POWER DESIGN ARCHITECTURE

(71) Applicant: Industrial Technology Research Institute, Hsinchu (TW)

(72) Inventors: Sheng-Che Hung, Hsinchu County (TW); Shih-Hsien Wu, Taoyuan City (TW); Hsu-Wei Liu, New Taipei City (TW); Tzong-Lin Wu, Taipei City (TW)

(73) Assignee: Industrial Technology Research Institute, Hsinchu (TW)

(21) Appl. No.: 18/149,158

(22) Filed: Jan. 3, 2023

(30) Foreign Application Priority Data
Oct. 19, 2022 (TW) 111139712

(51) Int. Cl. G06F 30/39

(52) U.S. Cl. CPC G06F 30/39; G06F 2119/06

(57) ABSTRACT

A power design architecture including a power supply circuit, a power wiring, at least one chip, a power ring, and a first reference conductor is provided. The power wiring is connected to the power supply circuit. The power ring is disposed around the chip and electrically connected to the chip and the power wiring. The first reference conductor is electrically connected to the chip. Low self-impedance is maintained at any position of the power ring.

### CROSS-REFERENCE TO RELATED APPLICATION

This application claims the priority benefit of Taiwanese application no. 111139712, filed on Oct. 19, 2022. The entirety of the above-mentioned patent application is hereby incorporated by reference herein and made a part of this specification.

### TECHNICAL FIELD

The disclosure relates to a circuit architecture, and relates to a power design architecture.

### BACKGROUND

The most common method to ensure power integrity (PI) is to add a decoupling capacitor, and this method is particularly suitable for solving the problem of voltage drop. In a load circuit, a local capacitor absorbs a transient supply current and helps meet the transient charge demand. However, the following problems arise. First, the number of passive capacitive components disposed increases; second, because the number of passive capacitive components disposed increases, an area required for placing passive capacitive components also increases; and third, there are different frequency settings under heterogeneous IC integration operation. The above-mentioned problems all cause troubles in the placement of decoupling capacitors.

Therefore, how to achieve the effect of low self-impedance without affecting the number of passive capacitive components is a technology that needs to be developed urgently.

### SUMMARY

A power design architecture according to an embodiment of the disclosure includes a power supply circuit, a power wiring, at least one chip, a power ring, and a first reference conductor. The power wiring is connected to the power supply circuit. The power ring is disposed around the chip and is electrically connected to the chip and the power wiring. The first reference conductor is electrically connected to the chip. Low self-impedance is maintained at any position of the power ring.

In an embodiment of the disclosure, the power design architecture further includes a first substrate, and the power wiring, the chip, the power ring, and the first reference conductor are all disposed on the first substrate. The first substrate is a dielectric plate.

In an embodiment of the disclosure, the power design architecture further includes a second reference conductor disposed on the same side of the first substrate as the chip and the power ring.

In an embodiment of the disclosure, the power design architecture further includes a second substrate and a second reference conductor. The second substrate is disposed between the first reference conductor and the second reference conductor, and the power ring is disposed in the second substrate.

### BRIEF DESCRIPTION OF THE DRAWINGS

FIG. 1A is a top view of a power design architecture according to the first embodiment of the disclosure.

FIG. 1B is a side view of the power design architecture of FIG. 1A.

FIG. 2A, FIG. 2B, and FIG. 2C are possible implementations in which the power ring is a closed ring.

FIG. 3A is a top view of a power design architecture according to the second embodiment of the disclosure.

FIG. 3B is a side view of the power design architecture of FIG. 3A.

FIG. 4A is a top view of a power design architecture according to the third embodiment of the disclosure.

FIG. 4B is a side view of the power design architecture of FIG. 4A.

FIG. 5A is a top view of a power design architecture according to the fourth embodiment of the disclosure.

FIG. 5B is a side view of the power design architecture of FIG. 5A.

FIG. 6A is a top view of a power design architecture according to the fifth embodiment of the disclosure.

FIG. 6B is a side view of the power design architecture of FIG. 6A.

FIG. 7A is a top view of a power design architecture according to the sixth embodiment of the disclosure.

FIG. 7B is a side view of the power design architecture of FIG. 7A.

FIG. 8A is a top view of a power design architecture according to the seventh embodiment of the disclosure.

FIG. 8B is a side view of the power design architecture of FIG. 8A.

FIG. 9A is a top view of a power design architecture according to the eighth embodiment of the disclosure.

FIG. 9B is a side view of the power design architecture of FIG. 9A.

FIG. 10A is a top view of a power design architecture according to the ninth embodiment of the disclosure.

FIG. 10B is a side view of the power design architecture of FIG. 10A.

FIG. 11 is a schematic view of a power design architecture according to the tenth embodiment of the disclosure.

### DETAILED DESCRIPTION OF DISCLOSED EMBODIMENTS

A power design architecture according to an embodiment of the disclosure includes a power supply circuit, a power wiring, a chip, a power ring, and a reference conductor. The power wiring and the reference conductor, and the power ring and the reference conductor respectively form a first power transmission wiring and a second power transmission wiring. The disclosure provides a power design architecture capable of lowering self-impedance. After electrical lengths and characteristic impedance of the first power transmission wiring and the second power transmission wiring are properly designed, the effect of maintaining low self-impedance is achieved at any position of the power ring, thereby suppressing the generation of voltage noise. In addition, since the power ring is around the chip, the power ring can supply power at any position. The power design architecture of the disclosure will be further described below.

### First Embodiment

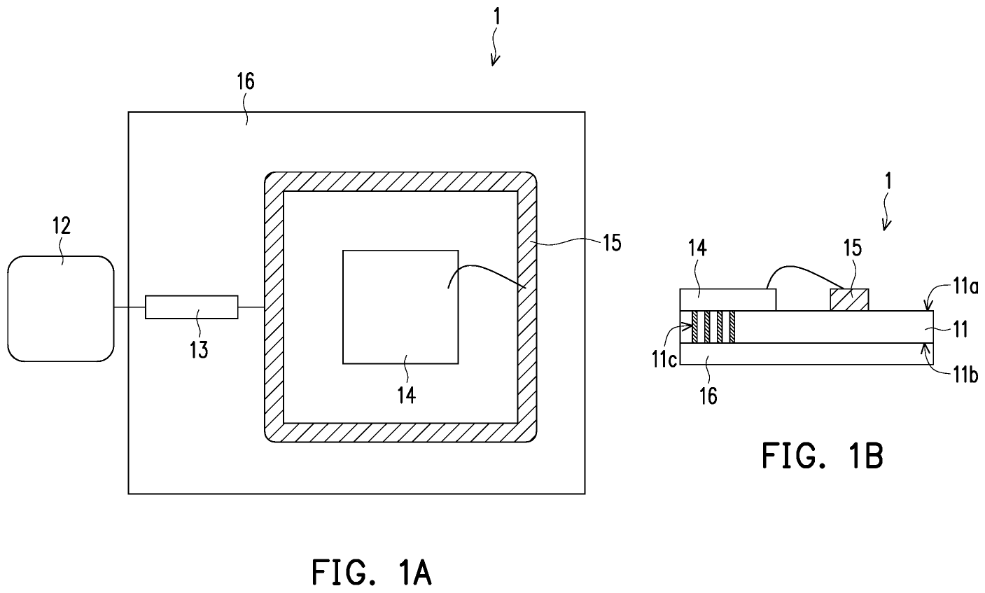

FIG. 1A is a top view of a power design architecture according to the first embodiment of the disclosure, and FIG. 1B is a side view of the power design architecture of FIG. 1A. In FIG. 1A, the first substrate is omitted and not shown. Referring to FIG. 1A and FIG. 1B at the same time, the power design architecture 1 of the embodiment includes a first substrate 11, a power supply circuit 12, a power wiring 13, at least one chip 14, a power ring 15, and a first reference conductor 16.

The first substrate 11 is a dielectric plate, and the first substrate 11 has a first side 11a and a second side 11b which are opposite to each other. The power wiring 13, the chip 14, and the power ring 15 are disposed on the first side 11a of the first substrate 11, and the first reference conductor 16 is disposed on the second side 11b of the first substrate 11.

The power wiring 13 disposed on the first side 11a of the first substrate 11 is connected between the power supply circuit 12 and the power ring 15, the power ring 15 is disposed around the chip 14, and the power ring 15 is electrically connected to the chip 14 and the power wiring 13. In the embodiment, the power ring 15 is a closed ring which is disposed around an outer side of the chip 14, and the chip 14 is electrically connected to the power ring 15 through one of methods such as wire bonding, metal wiring, bumps or solder balls, but is not limited thereto. Other possible electrical connection methods are also applicable. In the embodiment, the first substrate 11 is provided with a via 11c to electrically connect the chip 14 and the first reference conductor 16 by methods such as through-silicon via (TSV) or conductive post.

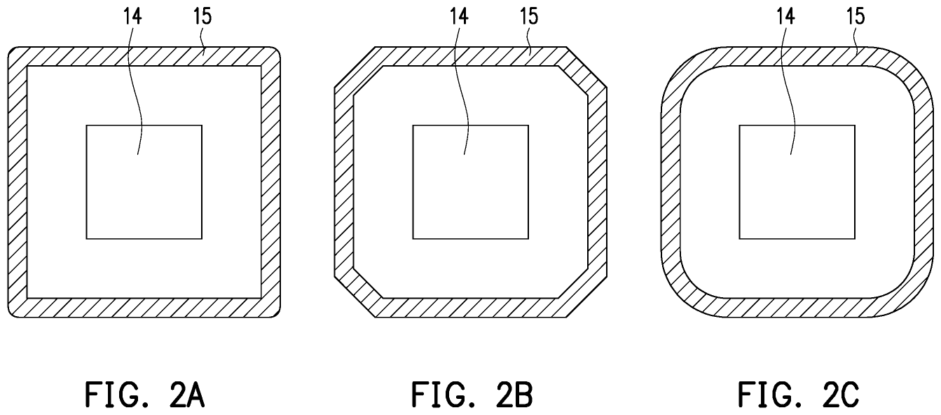

FIG. 2A, FIG. 2B and FIG. 2C are possible implementations in which the power ring is a closed ring. Referring to FIG. 2A, FIG. 2B, and FIG. 2C at the same time, the shape of the power ring 15 which is a closed ring can be a quadrangle, a polygon, or a quadrangle with rounded corners, but is not limited to the shape shown in the drawings of the embodiment. The quadrangle is not limited to a square shown in FIG. 2A, but also includes a rectangle. In addition, the polygon is not limited to an octagon shown in FIG. 2B, but may also be a quadrilateral, a pentagon, a hexagon, etc. In addition, the shape of the closed ring is not limited to the shapes shown in FIG. 2A, FIG. 2B, and FIG. 2C, but may also be circular or elliptical. It can be seen that the shape of the closed ring may be selected according to actual requirements of the arrangement and placement of the chips.

Based on the above, the first substrate 11 is provided with at least one via 11c penetrating the first side 11a and the second side 11b, and the first reference conductor 16 disposed on the second side 11b of the first substrate 11 passes through the via 11c to be electrically connected to the chip 14. In the embodiment, an orthographic projection range of a portion of the power wiring 13, the power ring 15, and the chip 14 falls within an orthographic projection range of the first reference conductor 16.

The above-mentioned power wiring 13 and the power ring 15 forms the first power transmission wiring, and the first reference conductor 16 is the second power transmission wiring. It is designed so that a length of the power wiring 13 is ¼ wavelength, and a length of the power ring 15 is an odd multiple of ½ wavelength.

Through the above-mentioned disposition, it can be seen that the power design architecture 1 of the embodiment can achieve the effect of low self-impedance at any position of the power ring 15 without using a bypass capacitor, thereby suppressing the voltage disturbance noise on a wiring, which is generated from the current drawn by the operation of the chip 14. In addition, since the power ring 15 is disposed around the chip 14, it is possible to supply power to any power pin of the chip 14 at any position of the power ring 15 nearby.

### Second Embodiment

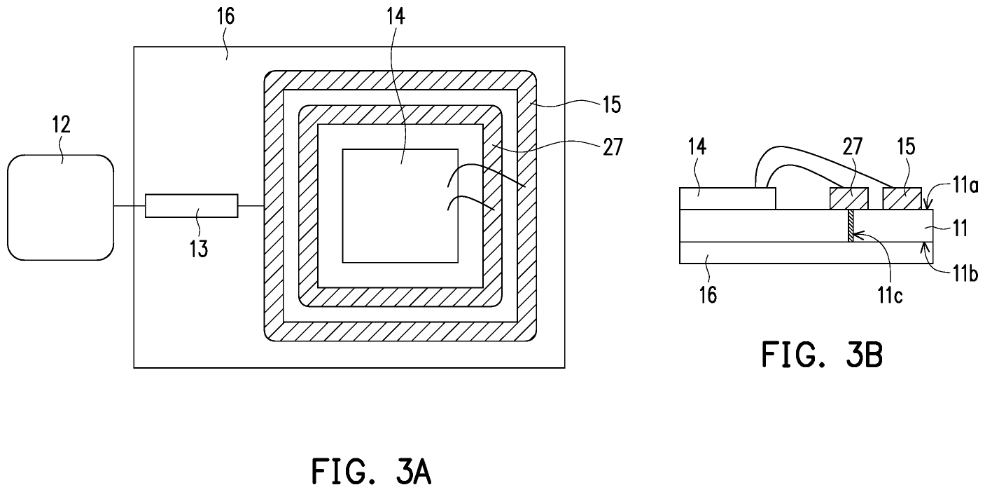

FIG. 3A is a top view of a power design architecture according to the second embodiment of the disclosure, and FIG. 3B is a side view of the power design architecture of FIG. 3A. In FIG. 3A, the first substrate is omitted and not shown. Referring to FIG. 3A and FIG. 3B at the same time, the embodiment is substantially the same as the aforementioned first embodiment, except that, compared with the first embodiment, the embodiment further includes a second reference conductor 27. The second reference conductor 27 is positioned between the power ring 15 and the chip 14.

In the embodiment, the second reference conductor 27 is disposed on the same side (that is, the first side 11a) of the first substrate 11 as the chip 14 and the power ring 15. Similarly, the chip 14 is electrically connected to the second reference conductor 27 and the power ring 15 by wire bonding. In addition, the second reference conductor 27 is electrically connected to the first reference conductor 16 through the via 11c. Also, the second reference conductor 27 is a closed ring between the power ring 15 and the chip 14.

### Third Embodiment

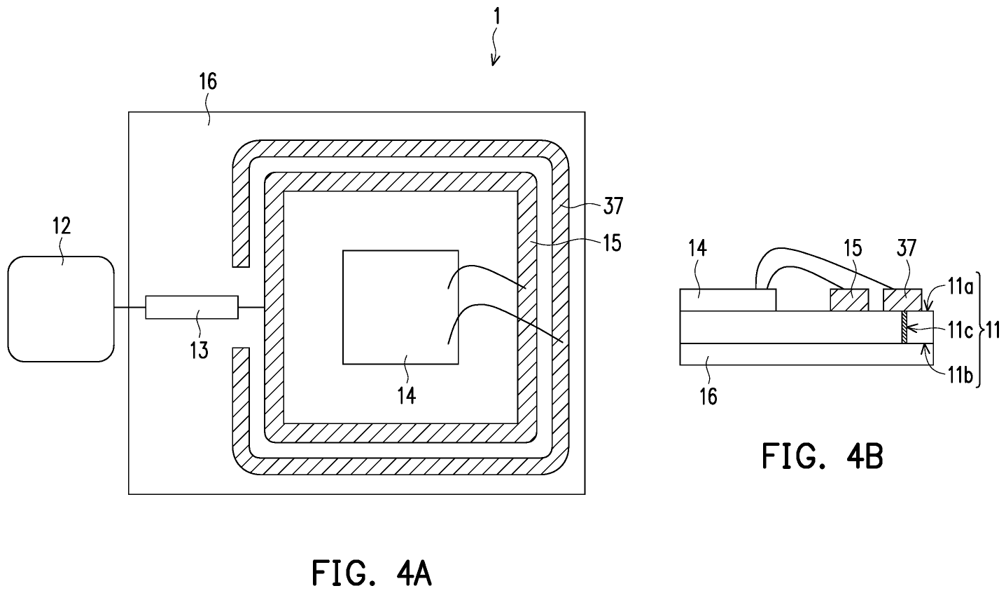

FIG. 4A is a top view of a power design architecture according to the third embodiment of the disclosure, and FIG. 4B is a side view of the power design architecture of FIG. 4A. In FIG. 4A, the first substrate is omitted and not shown. Referring to FIG. 4A and FIG. 4B at the same time, the embodiment is substantially the same as the aforementioned second embodiment, except that the shape and the disposed position of the second reference conductor 37 of the embodiment are different from the shape and the disposed position of the second reference conductor 27 of the second embodiment.

The second reference conductor 37 in the embodiment is a C-shaped ring, and the power ring 15 is positioned between the second reference conductor 37 and the chip 14.

### Fourth Embodiment

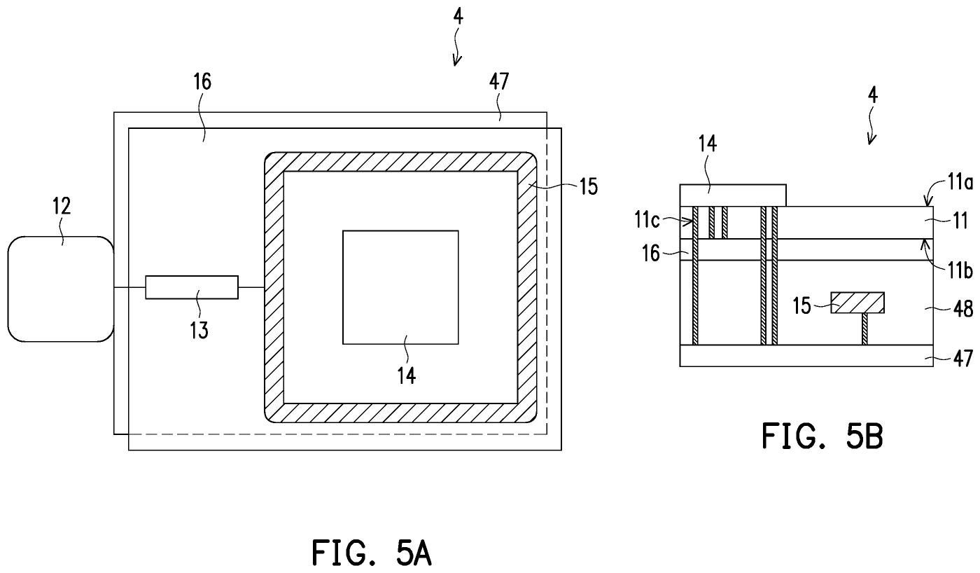

FIG. 5A is a top view of a power design architecture according to the fourth embodiment of the disclosure, and FIG. 5B is a side view of the power design architecture of FIG. 5A. In FIG. 5A, the first substrate is omitted and not shown. Referring to FIG. 5A and FIG. 5B at the same time, in the fourth embodiment of the disclosure, the power design architecture 4 further includes a second substrate 48 and a second reference conductor 47. The second substrate 48 is disposed between the first reference conductor 16 and the second reference conductor 47, and the power ring 15 is disposed in the second substrate 48.

The hierarchical disposition order from top to bottom is the chip 14, the first substrate 11, the first reference conductor 16, the second substrate 48, and the second reference conductor 47. The power ring 15 is positioned in the second substrate 48, and the chip 14 is electrically connected to the first reference conductor 16, the power ring 15, and the second reference conductor 47 through the plurality of vias 11c.

### Fifth Embodiment

The embodiment is substantially the same as the aforementioned first embodiment, except that the first reference conductor 56 of the embodiment is disposed on the same side of the first substrate 11 as the chip 14 and the power ring 15.

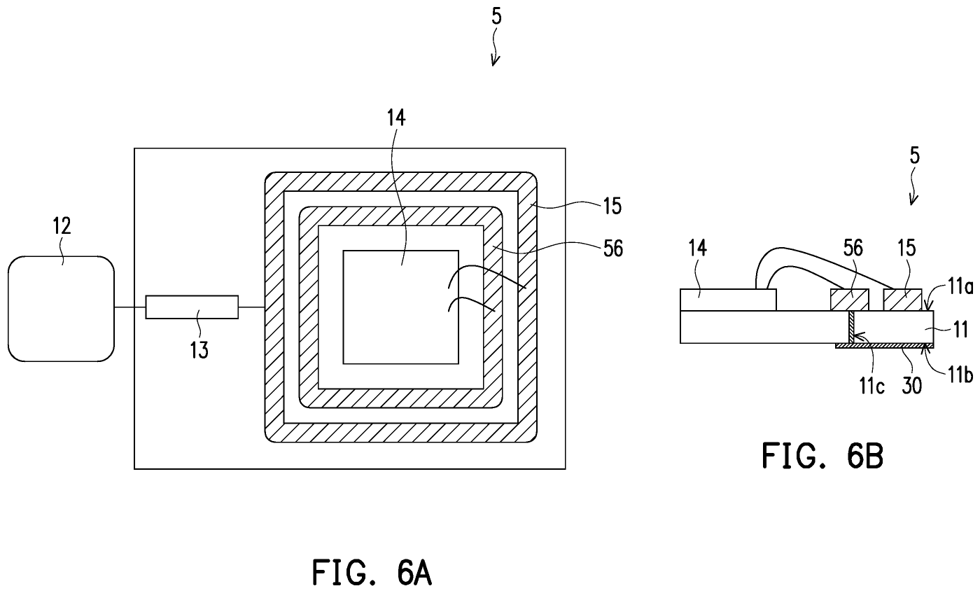

FIG. 6A is a top view of a power design architecture according to the fifth embodiment of the disclosure, and FIG. 6B is a side view of the power design architecture of FIG. 6A. Referring to FIG. 6A and FIG. 6B at the same time, in the embodiment, the first reference conductor 56 of the power design architecture 5 is disposed on the same side (that is, the first side 11a) of the first substrate 11 as the chip 14 and the power ring 15.

The above-mentioned first reference conductor 56 is a closed ring between the power ring 15 and the chip 14, and the first reference conductor 56 is connected to a transmission wiring 30 on the second side 11b of the first substrate 11 through the via 11c.

### Sixth Embodiment

The embodiment is substantially the same as the aforementioned fifth embodiment, except that the shape of the first reference conductor 66 of the embodiment is different from the shape of the first reference conductor 56 of the fifth embodiment.

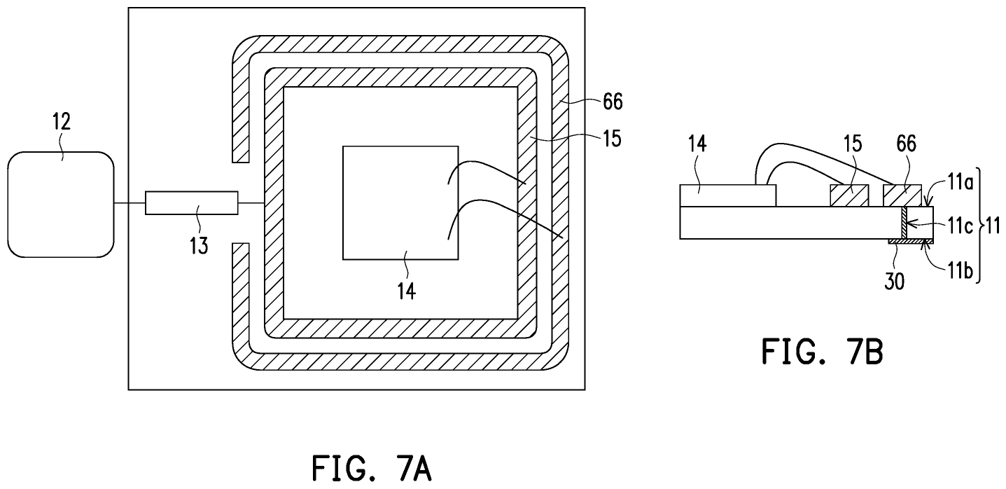

FIG. 7A is a top view of a power design architecture according to the sixth embodiment of the disclosure, and FIG. 7B is a side view of the power design architecture of FIG. 7A. Referring to FIG. 7A and FIG. 7B at the same time, in the embodiment, the first reference conductor 66 is a C-shaped ring, an opening of the C-shaped ring faces the power wiring 13, and the power ring 15 is positioned between the chip 14 and the first reference conductor 66.

Similarly, the first reference conductor 66 is connected to the transmission wiring 30 on the second side 11b of the first substrate 11 through the via 11c.

### Seventh Embodiment

The embodiment is substantially the same as the aforementioned first embodiment, except that an orthographic projection range of the chip 14 and an orthographic projection range of the first reference conductor 76 in the embodiment do not overlap each other, and the first reference conductor 76 is connected to the transmission wiring 30 disposed on the second side 11b of the first substrate 11.

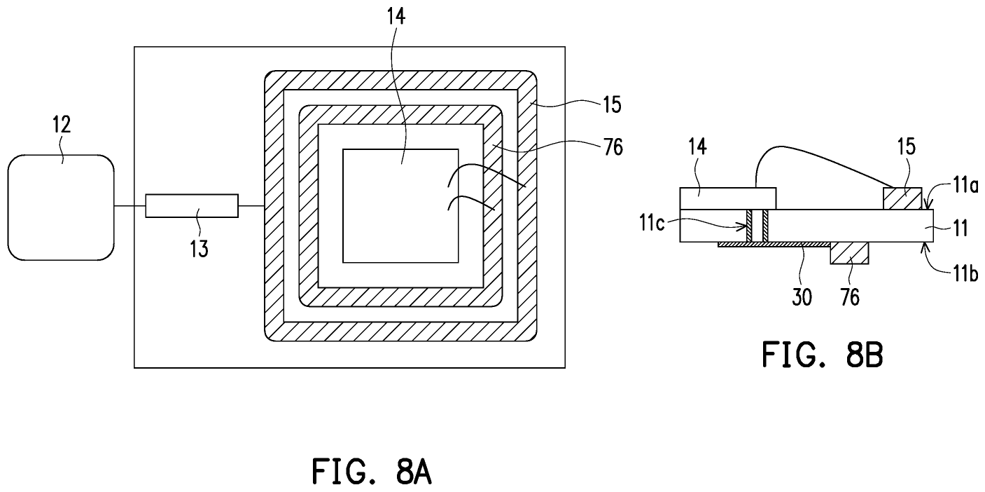

FIG. 8A is a top view of a power design architecture according to the seventh embodiment of the disclosure, and FIG. 8B is a side view of the power design architecture of FIG. 8A. Referring to FIG. 8A and FIG. 8B at the same time, in the embodiment, the first reference conductor 76 is a closed ring, and since the chip 14 and the first reference conductor 76 are positioned on different sides of the first substrate 11, the chip 14 is electrically connected to the first reference conductor 76 through the via 11c and the transmission wiring 30.

Although the disposed position of the first reference conductor 76 shown in FIG. 8B is positioned between the chip 14 and the power ring 15, it is not limited thereto. In an embodiment not illustrated here, the power ring 15 may also be disposed between the first reference conductor 76 and the chip 14; that is, the first reference conductor 76 can also be disposed outermost.

### Eighth Embodiment

The embodiment is substantially the same as the aforementioned first embodiment, except that, in the embodiment, there are a plurality of the power rings 15, and each power ring 15 corresponds to a different frequency.

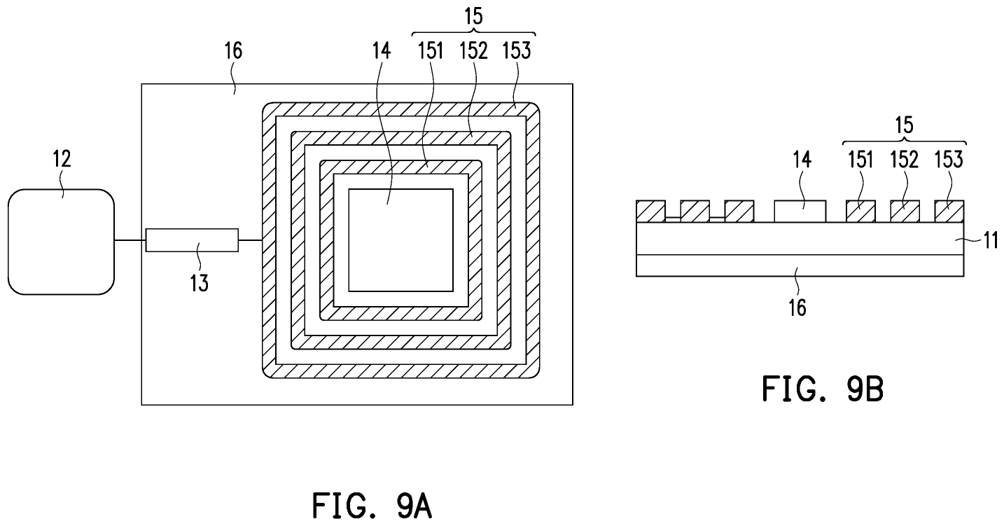

FIG. 9A is a top view of a power design architecture according to the eighth embodiment of the disclosure, and FIG. 9B is a side view of the power design architecture of FIG. 9A. In FIG. 9A, the first substrate is omitted and not shown. Referring to FIG. 9A and FIG. 9B at the same time, in the embodiment, the power rings 15 are disposed in plural. The plurality of power rings 151, 152, and 153 are all disposed on the first side 11a of the first substrate 11, and the power rings 151, 152, and 153 are electrically connected in series with each other. Although the embodiment illustrates three power rings as an example, the actual number of power rings is not limited thereto, and can be changed according to requirements.

### Ninth Embodiment

The embodiment is substantially the same as the aforementioned eighth embodiment, except that, in the embodiment, some of the power rings 15 are disposed on the first side 11a of the first substrate 11, and some of the power rings 15 are disposed on the second side 11b of the first substrate 11.

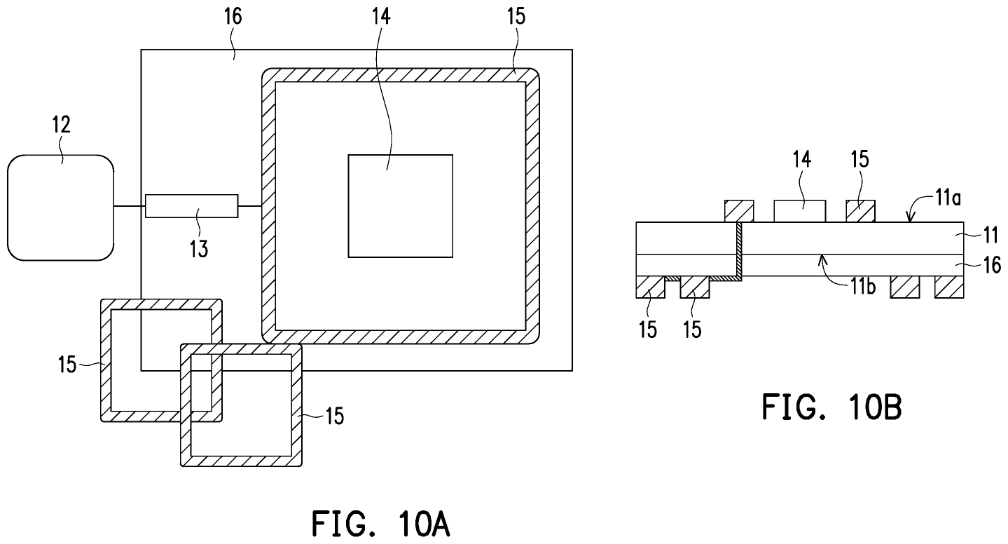

FIG. 10A is a top view of a power design architecture according to the ninth embodiment of the disclosure, and FIG. 10B is a side view of the power design architecture of FIG. 10A. In FIG. 10A, the first substrate is omitted and not shown. Referring to FIG. 10A and FIG. 10B at the same time, in the embodiment, the chip 14 and some of the power rings 15 are disposed on the first side 11a of the first substrate 11, and some of the power rings 15 are disposed on the second side 11b of the first substrate 11. Each power ring 15 corresponds to a different frequency. The plurality of power rings 15 are electrically connected to each other by wires (not shown).

### Tenth Embodiment

The embodiment is substantially the same as the aforementioned first embodiment, except that there are multiple chips 14, and the number of power rings 15 corresponds to the number of chips 14, and each chip 14 is correspondingly surrounded by one power ring 15.

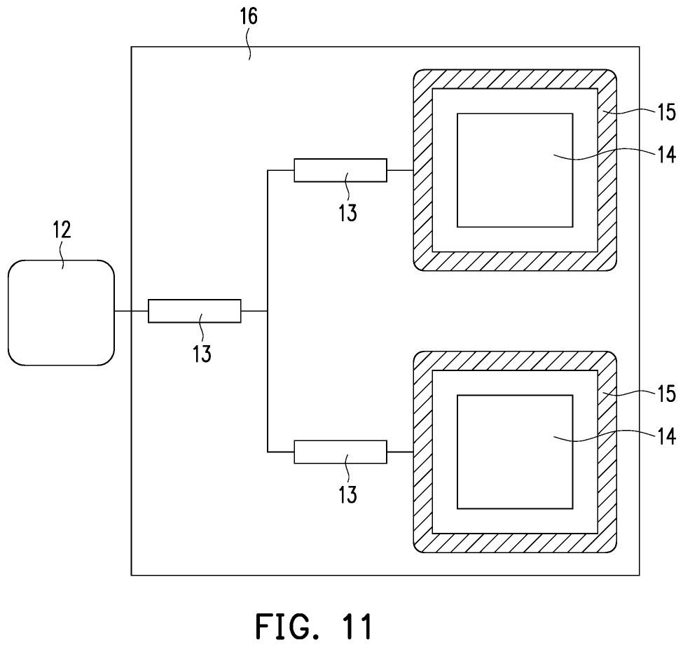

FIG. 11 is a schematic view of a power design architecture according to the tenth embodiment of the disclosure. In FIG. 11, the first substrate is omitted and not shown. Referring to FIG. 11, in the embodiment, each power ring 15 can provide different or the same operating frequency for different chips 14 to operate.

In the embodiment, the number of chips 14 provided is more than one. Similarly, although the above-mentioned other embodiments illustrate one chip as an example, the disclosure is not limited thereto. According to actual needs, a power ring can also be provided with a plurality of chips inside, and the disposition of other related components can be changed as required.

To sum up, in the power design architecture of the disclosure, by improving the connection path between the power supply and the chip in the package or the circuit board, the power supply can supply power to any power pin of the chip from any direction nearby. Moreover, without using bypass capacitors, low self-impedance is maintained at any position of the power ring, thereby suppressing the voltage disturbance on a wiring, which is generated from the current drawn by the operation of the chip.

What is claimed is:

1. A power design architecture, comprising:
a power supply circuit;
a power wiring connected to the power supply circuit;
at least one chip;
a power ring disposed around the chip and electrically connected to the chip and the power wiring; and
a first reference conductor electrically connected to the chip,
wherein low self-impedance is maintained at any position of the power ring.

2. The power design architecture of claim 1, further comprising:
a first substrate, wherein the power wiring, the chip, the power ring, and the first reference conductor are all disposed on the first substrate.

3. The power design architecture of claim 2, wherein the first substrate is a dielectric plate.

4. The power design architecture of claim 2, wherein the power ring and the chip are disposed on a first side of the first substrate, and the first reference conductor is disposed on a second side of the first substrate, and the first side and the second side are two opposite sides.

5. The power design architecture of claim 4, wherein the chip is electrically connected to the power ring through one of wire bonding, metal wiring, bumps or solder balls.

6. The power design architecture of claim 4, wherein the first substrate is provided with at least one via, and the chip is electrically connected to the first reference conductor through the via.

7. The power design architecture of claim 4, further comprising:
a second reference conductor disposed on the same side of the first substrate as the chip and the power ring.

8. The power design architecture of claim 7, wherein the second reference conductor is a closed ring and is positioned between the power ring and the chip.

9. The power design architecture of claim 7, wherein the second reference conductor is a C-shaped ring, and the power ring is positioned between the second reference conductor and the chip.

10. The power design architecture of claim 4, wherein the first reference conductor is a closed ring and is positioned between the chip and the power ring.

11. The power design architecture of claim 2, further comprising:
a second substrate and a second reference conductor, wherein the second substrate is disposed between the first reference conductor and the second reference conductor, and the power ring is disposed in the second substrate.

12. The power design architecture of claim 11, wherein the chip is electrically connected to the first reference conductor, the power ring, and the second reference conductor through at least one via.

13. The power design architecture of claim 2, wherein the first reference conductor, the chip, and the power ring are disposed on the same side of the first substrate.

14. The power design architecture of claim 13, wherein the first reference conductor is a closed ring and is positioned between the power ring and the chip.

15. The power design architecture of claim 13, wherein the first reference conductor is a C-shaped ring, and the power ring is positioned between the first reference conductor and the chip.

16. The power design architecture of claim 1, wherein the number of the power rings is plural, and each of the power rings corresponds to a different frequency.

17. The power design architecture of claim 16, wherein the power rings and the chip are disposed on the same side of a first substrate.

18. The power design architecture of claim 16, wherein some of the power rings and the chip are disposed on two opposite sides of a first substrate.

19. The power design architecture of claim 1, wherein the number of the chips is plural, the number of the power rings is plural, and each of the chips is correspondingly surrounded by one of the power rings.

20. The power design architecture of claim 1, wherein a length of the power wiring is of ¼ wavelength.

21. The power design architecture of claim 1, wherein a length of the power ring is an odd multiple of ½ wavelength.
